(19) United States
(12) Patent Application Publication
(10) Pub. No.: US 2014/0292277 A1
(43) Pub. Date: Oct. 2, 2014

(54) Vehicle Charging Device

(71) Applicant: SK Innovation Co., Ltd., Seoul (KR)

(72) Inventor: Je Hyun Chae, Daejeon (KR)

(21) Appl. No.: 14/356,490

(22) PCT Filed: Sep. 28, 2012
(86) PCT No.: PCT/KR2012/007941

§ 371 Date: May 6, 2014

(30) Foreign Application Priority Data
Nov. 9, 2011 (KR) 10-2011-0116521

(51) Int. Cl. B60L 11/18

(52) U.S. Cl. CPC B60L 11/1809
USPC 320/109

(57) ABSTRACT

Disclosed is a vehicle charging device for generating electricity by applying pressure to a piezoelectric element through tire rotation by preparing the piezoelectric element in a tire portion of a vehicle. The vehicle charging device according to one embodiment of the present invention includes: an elastic part interposed between a wheel and a tire of the vehicle to be expansible in a radius direction of the wheel and the tire; and a piezoelectric element prepared at an end (or ends) of one side of both sides of the elastic part to generate power by receiving a pressure from the elastic part and connected to a battery of the vehicle to charge the battery with the generated power.

### TECHNICAL FIELD

The present invention relates to a vehicle charging device.

### BACKGROUND ART

Vehicles have a battery to supply electricity to operate various components therein. Such a battery is a storage battery which generally supplies electricity to components within a vehicle and is charged by a generator driven according to a rotational movement of wheels when the vehicle runs.

With the advancement of technologies, an increasing number of electrical components are used in vehicles, increasing electricity consumption. In order to address the problem, simply, battery capacity may be increased. However, components in vehicles tend to be reduced in size and weight in terms of fuel efficiency, and thus, increasing battery capacity runs counter to the tendency and there is a limitation in increasing capacity. Thus, in order to solve the battery power shortage, research into reduction in power consumption of electric components of vehicles has been conducted, and on the other hand, a method for increasing a charge amount of a battery has been studied.

Korean Utility Model Laid-Open Publication No. 1998-0028334 (Entitled “Battery Charging Device using Piezoelectric Element”, dated Aug. 5, 1998), Korean Patent Laid-Open Publication No. 2003-0039692 (Entitled “Auxiliary Generator using Vehicle Suspension System”, dated May 22, 2003), Japanese Patent Laid-Open Publication No. 2011-041344 (Entitled “Generating Device”, dated Feb. 24, 2011), and the like, disclose various technologies to charge a battery as an assistant in line with charging by a generator. According to these technologies, auxiliary charging is performed by using a piezoelectric element provided in a suspension system of a vehicle. As well known, a suspension system refers to a system mitigating vertical vibrations of vehicle wheels, while supporting weight of a vehicle body based on elastic operation. Namely, a suspension system has pressure occasionally changed in a vertical direction when a vehicle runs, and by installing a piezoelectric element in the suspension system, a considerable auxiliary charging effect may be anticipated.

However, the auxiliary charging effect using a piezoelectric element provided in a suspension system is so volatile depending on road conditions (namely, a degree of vertical vibrations of a vehicle) or various running conditions that the piezoelectric element is not appropriate to be utilized as a stable auxiliary charging unit.

### RELATED ART

### Patent Documents

1. Korean Utility Model Laid-Open Publication No. 1998-0028334 (Entitled “Battery Charging Device using Piezoelectric Element”, published on Aug. 5, 1998)

2. Korean Patent Laid-Open Publication No. 2003-0039692 (Entitled “Auxiliary Generator using Vehicle Suspension System”, published on May 22, 2003)

3. Japanese Patent Laid-Open Publication No. 2011-041344 (Entitled “Generating Device”, published on Feb. 24, 2011)

### DISCLOSURE

### Technical Problem

An object of the present invention is to provide a vehicle charging device in which piezoelectric elements are installed in vehicle wheels and power is generated when pressure is applied to the piezoelectric elements according to rotation of the wheels.

### Technical Solution

In one general aspect, a vehicle charging device includes: an elastic part interposed between a wheel and a tire of a vehicle such that the elastic part is stretched and contracted in a direction of a radius of the wheel and the tire; and a piezoelectric element provided at an end of one side or both sides of the elastic part, generating power upon receiving pressure from the elastic part, and connected to a battery of the vehicle to charge the battery with generated power.

The vehicle charging device may further include: a pressure applying plate provided in one or both outer surfaces of the piezoelectric element to deliver applied pressure to the piezoelectric element.

The piezoelectric element may be provided in any one position selected from among an end of the elastic part at the side of the tire, an end of the elastic part at the side of the wheel, and both ends of the elastic part at the side of the wheel.

A plurality of piezoelectric elements may be radially disposed based on the center of the tire.

The piezoelectric element may be disposed within the tire.

The power generated by the piezoelectric element may be collected through the elastic part or a separate wire and delivered to the battery.

In another general aspect, a vehicle having a vehicle charging device includes: a battery; and the vehicle charging device including an elastic part interposed between a wheel and a tire of a vehicle such that the elastic part is stretched and contracted in a direction of a radius of the wheel and the tire, and a piezoelectric element provided at an end of one side of both sides of the elastic part, generating power upon receiving pressure from the elastic part, and connected to the battery of the vehicle to charge the battery with generated power, wherein the power generated by the piezoelectric element is collected through the elastic part or a separate wire and delivered to the battery.

### Advantageous Effects

According to embodiments of the present invention, auxiliary charging may be provided to a vehicle battery charged by a generator. Thus, power may be stably supplied to various vehicle components from the vehicle battery.

Also, power equal to or higher than a predetermined level may be stably generated regardless of running conditions when a vehicle runs. Thus, required performance of a battery may be reduced in consideration of auxiliary charging effects, and as a result, the battery may be miniaturized.

### DESCRIPTION OF DRAWINGS

The above and other objects, features and advantages of the present invention will become apparent from the following description of preferred embodiments given in conjunction with the accompanying drawings, in which:

FIG. 1 is a cross-sectional view illustrating a vehicle charging device according to the present invention.

FIGS. 2 through 5 are cross-sectional views illustrating several examples of the vehicle charging device according to an embodiment of the present invention.

FIG. 6 is a view illustrating an operational principle of the vehicle charging device according to an embodiment of the present invention.

FIG. 7 is a view illustrating a vehicle having vehicle charging device according to an embodiment of the present invention.

### DETAILED DESCRIPTION OF MAIN ELEMENTS

100: vehicle charging device (of the present invention)

110: elastic part 120: piezoelectric element

130: pressure applying plate 200: wheel

300: tire 400: battery

500: vehicle

### BEST MODE

Hereinafter, a vehicle charging device according to the embodiments of the present invention will be described in detail with reference to accompanying drawings.

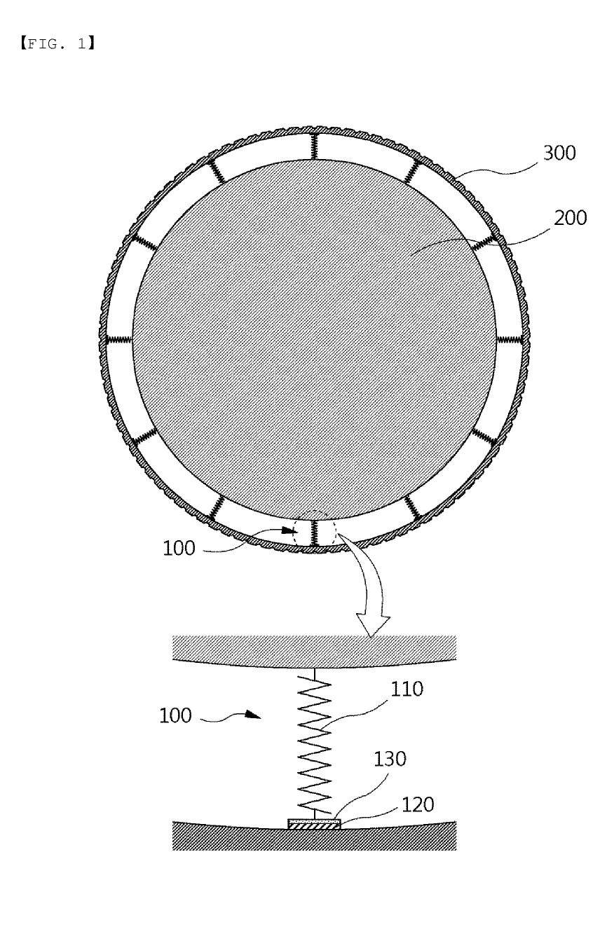

FIG. 1 is a cross-sectional view illustrating a representative embodiment of a vehicle charging device according to the present invention. As illustrated in FIG. 1, a vehicle charging device 100 according to an embodiment of the present invention includes an elastic part 110 and a piezoelectric element 120 provided in a wheel of a vehicle including a wheel 200 and a tire 300 (for reference, the shapes and dimensions of the elements are exaggerated for conspicuously illustrating the vehicle charging device of the present invention). FIG. 7 is a view schematically illustrating a vehicle 500 having a vehicle charging device, in which the vehicle 500 including a battery 400 and the vehicle charging device 100 connected to each other is schematically illustrated. In a lower side of FIG. 1, the vehicle charging device 100 according to an embodiment of the present invention is illustrated to be enlarged. Each of the elements will be described in detail with reference to FIG. 1.

As illustrated, the elastic part 110 is interposed between the wheel 200 and the tire 300 such that the elastic part 110 is stretched and contracted in a radius direction of the wheel 200 and the tire 300 of the vehicle. Namely, the elastic part 110 may be stretched or contracted as an interval between the wheel 200 and the tire 300 is changed. The elastic part 110 may be any one as long as it is stretched or contracted by external force and has elasticity to be returned to the original form. For example, the elastic part 110 may be a structure that may generate elasticity, like a spring, a block formed of a material having elasticity, like rubber, or the like.

The piezoelectric element 120 may be provided at an end (or ends) of one side or both sides of the elastic part 110. The piezoelectric element 120 may be formed of any material as long as it generates electricity under pressure. For example, the piezoelectric element 120 may be formed of a material such as quartz, tourmaline, barium titanate, or the like.

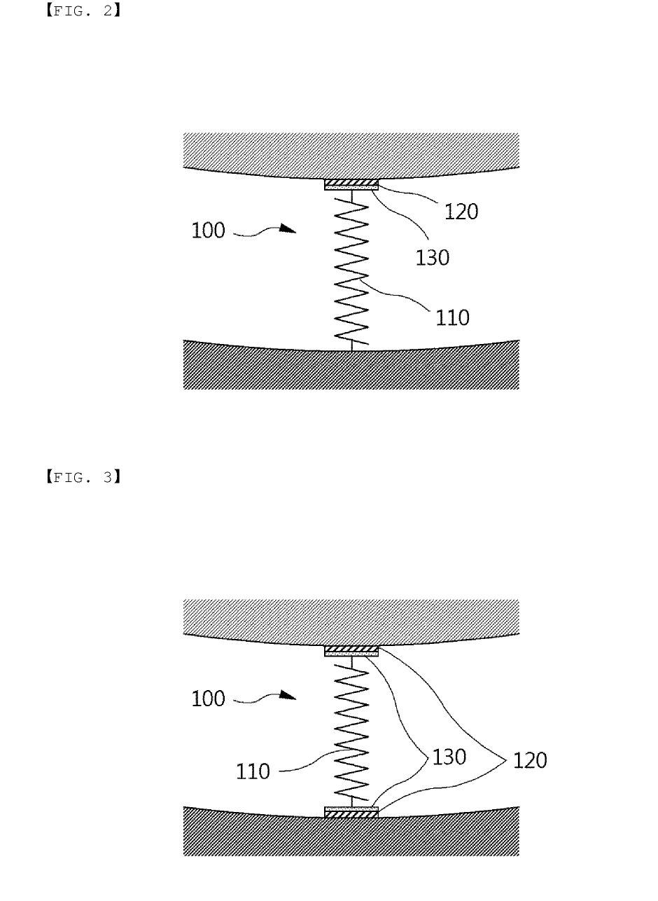

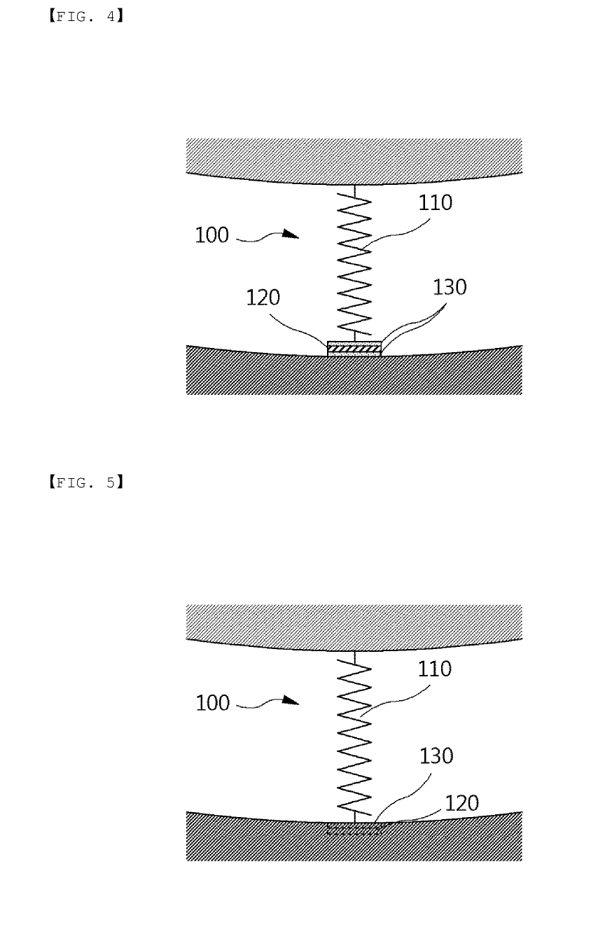

In the representative embodiment of FIG. 1, it is illustrated that the piezoelectric element 120 is provided only on one side of the tire 300 of the elastic part 110. FIGS. 2 through 5 illustrate vehicle charging devices according to various embodiments the present invention. Specifically, FIG. 2 illustrates an embodiment in which the piezoelectric element 120 is provided only on one side of the wheel 200 of the elastic part 110, FIG. 3 illustrates an embodiment in which the piezoelectric elements 120 are provided at both sides of the elastic part 110. In this manner, the piezoelectric element 120 may be provided in any one of one end of the wheel 200 or the tire 300 and both ends of the elastic part 110 as long as it may be pressed by the elastic part 110.

As described above, the elastic part 110 may be stretched or contracted as an interval between the wheel 200 and the tire 300 is changed, and accordingly, the elastic part 100 has elastic force. The elastic force presses the piezoelectric element 120 provided in the end of the elastic part 110, and when the piezoelectric element 120 is pressed by the elastic part 110, power is generated. Here, since the piezoelectric element 120 is electrically connected to the battery of a vehicle, power generated by the piezoelectric element 120 is collected through the electric unit 110 or a separate wire and delivered to the battery to charge the battery. In other words, the elastic part 110 is generally formed of a metal, having electrical conductivity, and thus, the elastic part 110 itself may be used as a conductor to collect power, and of course, a separate wire may be further connected to the piezoelectric element 120 to collect power. In the process of delivering power collected in the vehicle wheel to the battery, if a wire is used, the wire may be entangled due to a rotation of the vehicle wheel. In order to prevent this, a structure for preventing entanglement of the wire that receives power from the collector of the vehicle wheel may be provided in the wire, or a structure in which, based on a fact that most vehicle components are formed of a metal having electrical conduction, components of a connection part of the vehicle are adjusted to be electrically connected and a wire is connected to a portion free of entanglement, or the like, may also be used. In this manner, any structure may be used without departing from the scope and spirit of the present invention, as long as it may deliver power collected from the piezoelectric element 120 to the battery.

The vehicle charging device 100 according to the embodiment of the present invention may include only the elastic part 110 and the piezoelectric element 120 as described above. Meanwhile, when pressure of the elastic part 110 is applied to a surface of the piezoelectric element 120, pressure may not be evenly distributed to be applied to the entire surface of the piezoelectric element 120 due to a small area of the contact portion, or due to this problem, impact may be applied to an outer cover of the piezoelectric element 120 to damage it. Thus, as illustrated in FIGS. 1, 2, and 3, the vehicle charging device 100 according to the embodiment of the present invention may further include a pressure applying plate 130 that may be provided in one outer surface of the piezoelectric element 120 or may be provided in both surfaces of the piezoelectric element 120 as illustrated in FIG. 4 to deliver applied pressure to the piezoelectric element 120. In detail, the pressure applying plate 130 serves to distribute pressure delivered from the elastic part 110 and the tire 300 to the entire surface thereof, whereby pressure may be evenly distributed and delivered in a direction of the area of the piezoelectric element 120, improving power generation characteristics of the piezoelectric element 120. Thus, since pressure is evenly distributed by the pressure applying plate 130, transfer of excessive pressure to a portion of the piezoelectric element 120 may be prevented, and thus, the provision of the pressure applying plate 130 may obtain an additional effect of lowering the potential for damaging the piezoelectric element 120.

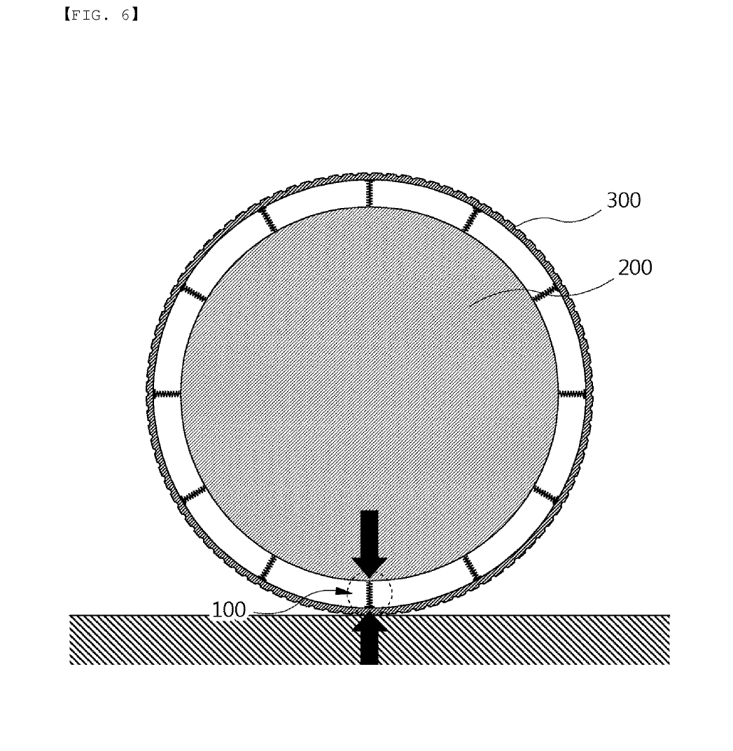

In addition, as illustrated in FIG. 5, the piezoelectric element 120 may be provided to be disposed within the tire 300. In general, the tire 300 has a structure including several layers, so the piezoelectric element 120 may be provided within the tire 300 so as to be stably disposed. In this case, the pressure applying plate 130 may be provided within the tire 300 together with the piezoelectric element 120, or may be provided outside of the tier 300 such that a position of the piezoelectric element 120 may be easily recognized from the outside.

As illustrated in FIGS. 2 through 5, in the vehicle charging device 100, the piezoelectric element 120 may be provided in any of one end of the wheel 200 and one end or both ends of the tire 300 of the elastic part 110 or may be provided within the tire 300, and the pressure applying plate 130 may be provided in one or both surfaces of the piezoelectric element 120. Namely, various modifications may be implemented. In other words, the present invention is not limited to the configurations of FIGS. 2 through 5, and the piezoelectric element 120 may be provided on both sides of the elastic part 110 and the pressure applying plate 130 is provided on both surfaces of the piezoelectric element 120. In this manner, the vehicle charging device 100 may be variously modified without departing from the scope and spirit of the present invention.

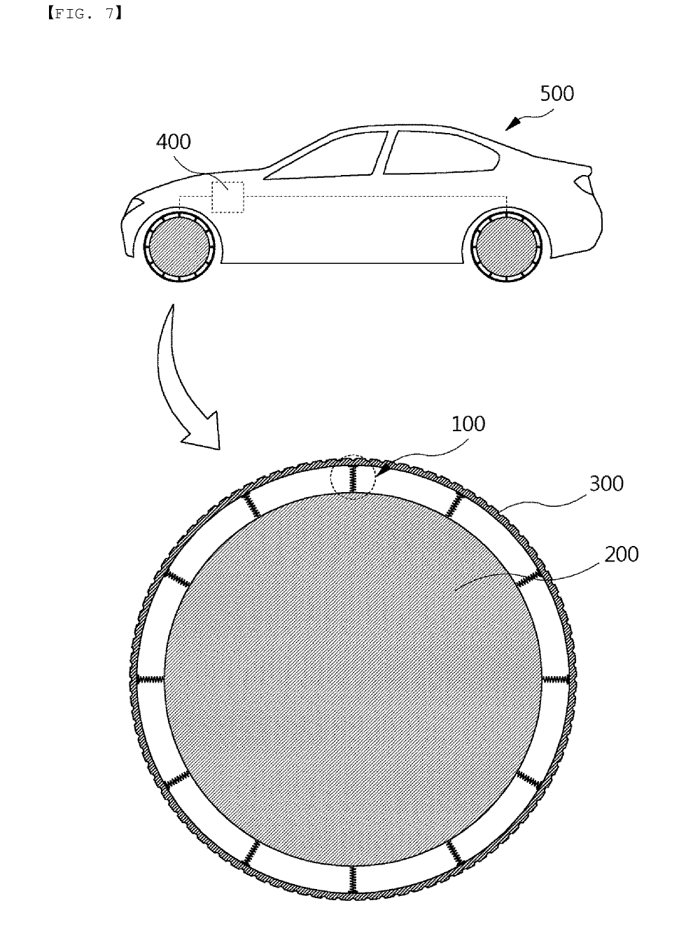

FIG. 6 illustrates an operating principle of the vehicle charging device according to an embodiment of the present invention. As illustrated in FIG. 6, in a position of the tire 300 in contact with the ground, force is applied to the tire 300 from the ground in a direction perpendicular to the ground. An interval between the wheel 200 and the tire 300 is naturally narrowed by force 300 applied from the ground. Here, as illustrated in FIG. 6, when the vehicle charging apparatus 100 is disposed to be parallel to the vertical direction, an interval between the wheel 200 and the tire 300 is narrowed to make the elastic part 110 contracted, and thus, elastic force of the elastic part 110 is applied to pressure the piezoelectric element 120 provided in one end of the elastic part 110. Here, since the tire 300 is directly in contact with the ground so as to be deformed, generating pressure, so, in order to effectively deliver pressure, preferably, the piezoelectric element 120 is provided in the end of the elastic part 110 at the side of the tire 300 as illustrated in FIGS. 1 and 6.

When the vehicle runs, the wheels thereof continuously make a rotary movement, and in this case, a single vehicle charging device 100 is pressed once at every rotation, generating power. When the vehicle runs, the wheels thereof are inevitably rotated. Thus, the vehicle charging device 100 according to the embodiment of the present invention that generates power according to rotation of the wheels has far more chance to generate power, compared with an auxiliary charging device using a piezoelectric element provided in the related art suspension system, obtaining a significant effect of increasing an amount of power generation, compared with the related art.

In order to further increase the effect, a plurality of vehicle charging devices 100 according to the embodiment of the present invention may be provided to be disposed radially on the wheel 200 12 illustrated in FIGS. 1 and 6. Through this configuration, power corresponding to the number of the vehicle charging devices 100 may be generated each time when the wheel is rotated once, and thus, an amount of power generation may be further increased.

While embodiments have been shown and described above, it will be apparent to those skilled in the art that modifications and variations could be made without departing from the spirit and scope of the present invention as defined by the appended claims.

### INDUSTRIAL APPLICABILITY

According to embodiments of the present invention, auxiliary charging may be provided to a vehicle battery charged by a generator. Thus, power may be stably supplied to various vehicle components from the vehicle battery.

Also, power equal to or higher than a predetermined level may be stably generated regardless of running conditions when a vehicle runs. Thus, required performance of a battery may be reduced in consideration of auxiliary charging effects, and as a result, the battery may be miniaturized.

1. A vehicle charging device comprising:
an elastic part interposed between a wheel and a tire of a vehicle such that the elastic part is stretched and contracted in a direction of a radius of the wheel and the tire; and
a piezoelectric element provided at an end of one side or both sides of the elastic part, generating power upon receiving pressure from the elastic part, and connected to a battery of the vehicle to charge the battery with generated power.

2. The vehicle charging device of claim 1, further comprising:
a pressure applying plate provided in one or both outer surfaces of the piezoelectric element to deliver applied pressure to the piezoelectric element.

3. The vehicle charging device of claim 1, wherein the piezoelectric element is provided in any one position selected from among an end of the elastic part at the side of the tire, an end of the elastic part at the side of the wheel, and both ends of the elastic part at the side of the wheel.

4. The vehicle charging device of claim 1, wherein a plurality of piezoelectric elements are radially disposed based on the center of the tire.

5. The vehicle charging device of claim 1, wherein the piezoelectric element is disposed within the tire.

6. The vehicle charging device of claim 1, wherein the power generated by the piezoelectric element is collected through the elastic part or a separate wire and delivered to the battery.

7. A vehicle having a vehicle charging device, comprising:
a battery; and
the vehicle charging device including an elastic part interposed between a wheel and a tire of a vehicle such that the elastic part is stretched and contracted in a direction of a radius of the wheel and the tire, and a piezoelectric element provided at an end of one side or both sides of the elastic part, generating power upon receiving pressure from the elastic part, and connected to the battery of the vehicle to charge the battery with generated power,
wherein the power generated by the piezoelectric element is collected through the elastic part or a separate wire and delivered to the battery.
